(19) United States
(12) Patent Application Publication
(10) Pub. No.: US 2017/0177542 A1
(43) Pub. Date: Jun. 22, 2017

(54) Operating a VLIW Processor in a Wireless Sensor Device

(71) Applicant: Cognitive Systems Corp., Waterloo (CA)

(72) Inventors: Karanvir Chattha, Waterloo (CA); Nebu John Mathai, Waterloo (CA)

(73) Assignee: Cognitive Systems Corp., Waterloo (CA)

(21) Appl. No.: 14/971,299

(22) Filed: Dec. 16, 2015

(51) Int. Cl. G06F 15/78; G06F 9/38

(52) U.S. Cl. CPC G06F 15/7839; G06F 9/38

(57) ABSTRACT

In some aspects of what is described, a wireless sensor device includes a radio frequency (RF) processor system. The RF processor system includes a very large instruction word (VLIW) processor device that has multiple execution units. The RF processor system also includes storage units and an interconnect device. The storage units store instruction words to be routed to the execution units. The interconnect device provides connectivity between the storage units and the execution units. The interconnect device is adapted to route instruction words from storage units to respective execution units according to routing indices for each clock cycle of the VLIW device.

### BACKGROUND

The following description relates to operating a very long instruction word (VLIW) processor in a wireless sensor device.

Very long instruction word (VLIW) processors have multiple execution units to process multiple instructions in parallel. Typically, each execution unit of the VLIW processor can execute an instruction word during each clock cycle of the VLIW processor. An execution unit may receive an “NOP” instruction, indicating that the execution unit is not operated during the corresponding clock cycle.

### SUMMARY

In a general aspect of what is described here, instructions are communicated to a very long instruction word (VLIW) processor device.

In some aspects, a processor system includes a very large instruction word (VLIW) processor device that has multiple execution units. The processor system also includes storage units and an interconnect device. The storage units store instruction words to be routed to the execution units. The interconnect device provides connectivity between the storage units the execution units. The interconnect device is adapted to access routing indices for a clock cycle of the VLIW processor device. The interconnect device is also adapted to route the instruction words from one or more of the storage units to one or more of the execution units according to the routing indices for the clock cycle.

In some aspects, instruction words are stored at respective storage units in a processor system. At an interconnect device that provides connectivity between the storage units and execution units of a VLIW processor device, routing indices for clock cycle of the VLIW processor device are accessed. The instruction words are routed from one or more of the storage units to one or more of the execution units according to the routing indices.

In some aspects, the processor system is a radio frequency (RF) processor system in a wireless sensor device.

Implementations of these and other aspects may include one or more of the following features. The routing indices for the clock cycle can indicate, for each execution unit, whether the execution unit receives an instruction word to be executed on the clock cycle. The routing indices can include a binary value representing an NOP instruction for at least one of the execution units.

Implementations of these and other aspects may include one or more of the following features. The VLIW processor device can include N execution units, and the processor system can include N storage units. The processor system can include an N-to-N interconnect device that provides N-to-N connectivity between the N storage units and the N execution units.

Implementations of these and other aspects may include one or more of the following features. The processor system can include an index store that stores routing indices for multiple clock cycles of the VLIW processor device. The interconnect device can be adapted to access the routing indices for each clock cycle from the index store. The index store can store a binary routing matrix that includes the routing indices for the multiple clock cycles. The processor system can include a main storage device that stores instruction words to be communicated to the storage units.

Implementations of these and other aspects may include one or more of the following features. A first connection can be provided between a first one of the storage units and a first one of the execution units according to the routing indices for a first clock cycle. A first one of the instruction words can be routed from the first storage unit to the first execution unit through the first connection. A second, different connection can be provided between the first storage unit and a second, different one of the execution units according to routing indices for a second, subsequent clock cycle. A second instruction word can be routed from the first storage unit to the second execution unit through the second connection.

In some instances, implementations of these and other aspects may provide advantages. For example, instructions for a VLIW processor device may require less memory. As another example, instructions for a VLIW processor device may be routed according to a general scheme that does not rely on profiling.

The details of one or more implementations are set forth in the accompanying drawings and the description below. Other features, objects, and advantages will be apparent from the description and drawings, and from the claims.

### DESCRIPTION OF DRAWINGS

FIG. 1A is a block diagram showing aspects of an example wireless sensor device.

FIG. 1B is a schematic diagram showing an example processor system.

FIG. 2 is a schematic diagram showing an example instruction set.

FIG. 3 is a schematic diagram showing an example signal path in a wireless sensor device.

### DETAILED DESCRIPTION

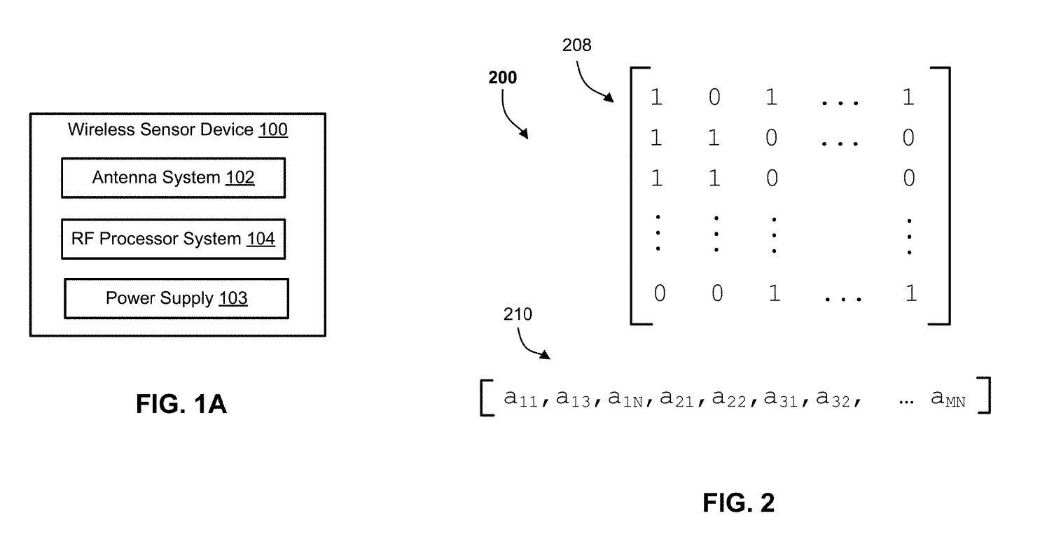

FIG. 1A is a block diagram showing aspects of an example wireless sensor device 100. As shown in FIG. 1A, the wireless sensor device 100 includes an antenna system 102, a radio frequency (RF) processor system 104 and a power supply 103. A wireless sensor device may include additional or different features and components, and the components can be arranged as shown or in another manner.

In operation, the wireless sensor device 100 can detect and analyze wireless signals. In some implementations, the wireless sensor device 100 can detect signals exchanged according to a wireless communication standard (e.g., for a cellular network), although the wireless sensor device itself is not part of the cellular network. In some instances, the wireless sensor device 100 monitors RF signals by “listening” or “watching” for RF signals over a broad range of frequencies and processing the RF signals that it detects. There may be times when no RF signals are detected, and the wireless sensor device 100 may process RF signals (e.g., from time to time or continuously) as they are detected in the local environment of the wireless sensor device 100.

The example antenna system 102 is communicatively coupled with the RF processor system 104, for example, by wires, leads, contacts or another type of coupling that allows the antenna system 102 and the RF processor system 104 to exchange RF signals. In some instances, the antenna system 102 wirelessly receives RF signals from the electromagnetic environment of the wireless sensor device 100 and transfers the RF signals to the RF processor system 104 to be processed (e.g., digitized, analyzed, stored, retransmitted, etc.). In some instances, the antenna system 102 receives RF signals from the RF processor system 104 and wirelessly transmits the RF signals from the wireless sensor device 100.

The example RF processor system 104 can include one or more chips, chipsets, or other types of devices that are configured to process RF signals. For example, the RF processor system 104 may include one or more processor devices that are configured to identify and analyze data encoded in RF signals by demodulating and decoding the RF signals transmitted according to various wireless communication standards. In some cases, the RF processor system 104 includes a VLIW processor device. For example, the RF processor system 104 may include features of the processor system 110 shown in FIG. 1B or another type of processor system. The VLIW processor device includes multiple execution units to process multiple instructions in parallel. For instance, the wireless sensor device 100 may provide significant computing resources to process large instructions sets for analyzing wireless signals in real time.

In some implementations, the RF processor system 104 handles instructions for a VLIW processor device with high instruction memory utilization, for instance, even when the compiler is not able to schedule instruction words in all available slots of the VLIW processor device (e.g., when the compiler inserts a “NOP” or empty set in the unused instruction slot). For instance, the RF processor system may use a compression scheme that provides a high compression ratio for the instructions. In some cases, the compression scheme uses a binary routing matrix to construct an operation flow with NOP instructions and non-NOP instructions. For example, the binary routing matrix can include a first binary index (e.g., “1”) to indicate all non-NOP instructions in the order they are to be applied, and another binary index (e.g., “0”) to indicate all NOP instructions in the order they are to be applied. In such examples, the NOP instructions can be reduced to a single bit, thus requiring less memory than some existing schemes.

In some implementations, the RF processor system 104 is configured to monitor and analyze signals that are formatted according to one or more communication standards or protocols, for example, 2G standards such as Global System for Mobile (GSM) and Enhanced Data rates for GSM Evolution (EDGE) or EGPRS; 3G standards such as Code Division Multiple Access (CDMA), Universal Mobile Telecommunications System (UMTS), and Time Division Synchronous Code Division Multiple Access (TD-SCDMA); 4G standards such as Long-Term Evolution (LTE) and LTE-Advanced (LTE-A); wireless local area network (WLAN) or WiFi standards such as IEEE 802.11, Bluetooth, near-field communications (NFC), millimeter communications; or multiple of these or other types of wireless communication standards. In some cases, the RF processor system 104 is capable of extracting available characteristics, synchronization information, cells and services identifiers, quality measures of RF, physical layers of wireless communication standards and other information. In some implementations, the RF processor system 104 is configured to process other types of wireless communication (e.g., non-standardized signals and communication protocols).

In some implementations, the RF processor system 104 can perform various types of analyses in the frequency domain, the time domain, or both. In some cases, the RF processor system 104 is configured to determine bandwidth, power spectral density, or other frequency attributes of detected signals. In some cases, the RF processor system 104 is configured to perform demodulation and other operations to extract content from the wireless signals in the time domain such as, for example, signaling information included in the wireless signals (e.g., preambles, synchronization information, channel condition indicator, SSID/MAC address of a WiFi network). The RF processor system 104 and the antenna system 102 can operate based on electrical power provided by the power supply 103. For instance, the power supply 103 can include a battery or another type of component that provides an AC or DC electrical voltage to the RF processor system 104.

In some cases, the wireless sensor device 100 is implemented as a compact, portable device that can be used to sense wireless signals and analyze wireless spectrum usage. In some implementations, the wireless sensor device 100 is designed to operate with low power consumption (e.g., around 0.1 to 0.2 Watts or less on average). In some implementations, the wireless sensor device 100 can be smaller than a typical personal computer or laptop computer and can operate in a variety of environments. In some instances, the wireless sensor device 100 can operate in a wireless sensor network or another type of distributed system that analyzes and aggregates wireless spectrum usage over a geographic area. For example, in some implementations, the wireless sensor device 100 can be used as described in U.S. Pat. No. 9,143,168, entitled, “Wireless Spectrum Monitoring and Analysis,” or the wireless sensor device 100 can be used in another type of environment or operate in another manner.

FIG. 1B is a schematic diagram showing an example processor system 110. In some cases, all or part of the example processor system 110 can be included in the RF processor system 104 shown in FIG. 1A. For example, the processor system 110 may be configured to receive and analyze RF signals detected by an antenna system. The processor system 110 can be included in other types of systems and devices. The example processor system 110 in FIG. 1B includes a main store 111, a dynamic memory allocation (DMA) unit 112, a bus 113, a cache 115, an interconnect device 114, a very large instruction word (VLIW) processor device 117, an index store 119 and a pre-fetch queue 120. In the example shown, the cache 115 includes N storage units 116A, 116B, . . . 116N, the VLIW processor device 117 includes N execution units 118A, 118B, . . . 118N, and the interconnect device 114 is an N-to-N interconnect device (where N is an integer). The processor system 110 may include additional or different features, and the features of a processor system may be arranged as shown or in another manner.

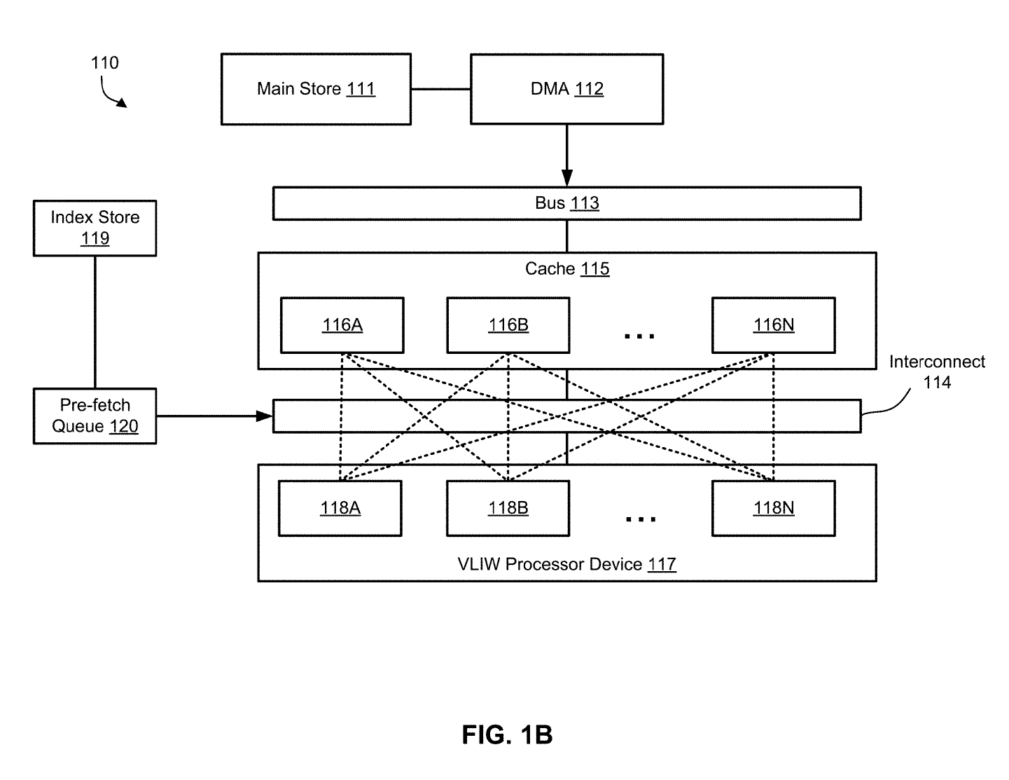

The example processor system 110 can perform operations by storing and processing instruction sets for the VLIW processor device 117. In some examples, the processor system 110 stores and processes instruction sets formatted as the example instruction set 200 shown in FIG. 2, which includes a binary routing matrix 208 and a set of instruction words 210. The processor system 110 may store and process larger or smaller instructions sets, or the processor system 110 may store and process instruction sets that are formatted in another manner.

The example processor system 110 includes three memory devices that can store binary information. The three example memory devices shown are the main store 111, the cache 115 and the index store 119. The processor system 110 may include additional or different memory devices. The memory devices can include volatile memory devices (e.g., static random access memory, dynamic random access memory, special purpose logic circuitry, etc.) or non-volatile memory devices (e.g., flash memory, various forms of read-only memory, etc.).

The example main store 111 includes memory to store instructions for the VLIW processor device 117. For instance, the main store 111 can store the set of instruction words 210 shown in FIG. 2, or the main store 111 can store instructions in another (compressed or uncompressed) format or another type of information.

The example DMA unit 112 is connected between the main store 111 and the bus 113. The DMA unit 112 is operable to generate memory addresses, initiate read and write operations in one or more of the memory devices (e.g., the main store 111, the cache 115, etc.), and perform other operations related to memory devices. In some instances, the DMA unit 112 can access information stored in the main store 111 and distribute the information to other devices (e.g., to the cache 115) over the bus 113. For example, the DMA unit 112 can access instruction words in the main store 111 and communicate the instruction words to the cache 115 over the bus 113.

The example bus 113 provides a physical connection between the DMA unit 112 and the cache 115. For instance, the bus 113 may include one or more wires, fibers, or other physical paths adapted to transfer information between the DMA unit 112 and the cache 115. The bus 113 may provide connections between other devices or components in the processor system 110.

The example cache 115 includes N storage units 116A, 116B, . . . 116N. The integer N can be, for example, twelve (12), sixteen (16) or another value. In the example shown, the integer N is also the number of execution units 118A, 118B, . . . 118N in the VLIW processor device 117. Thus, in this example, the number of storage units 116A, 116B, . . . 116N in the cache 115 is equal to the number of execution units 118A, 118B, . . . 118N in the VLIW processor device 117.

Each of the example storage units 116A, 116B, . . . 116N in the cache 115 includes memory to store an instruction word for the VLIW processor device 117. For instance, the cache 115 can store N of the instruction words 210 shown in FIG. 2, with the first storage unit 116A storing a first one of the instruction words (e.g., a₁₁), the second storage unit 116B storing a second one of the instruction words (e.g., a₁₃), etc. In the example shown, the cache 115 can store all the instruction words for at least one clock cycle of the VLIW processor device 117. In some instances (for clock cycles that include one or more NOP instructions), the cache 115 can store instruction words for multiple clocks of the VLIW processor device 117.

The example storage units 116A, 116B, . . . 116N store instruction words to be routed to the individual execution units 118A, 118B, . . . 118N. The example storage units 116A, 116B, . . . 116N in the cache 115 can be implemented as N independent “mini-stores.” In the example shown, the stores are decoupled to allow increased compression and to allow the execution units 118A, 118B, . . . 118N in the VLIW processor device 117 to be continuously fed.

The example interconnect device 114 provides connectivity between the storage units 116A, 116B, . . . 116N and the execution units 118A, 118B, . . . 118N. In the example shown, the interconnect device 114 includes routing logic that can make a connection between any storage unit and any execution unit, and the routing logic can modify the connections for each clock cycle. The interconnect device 114 can use the connections to communicate instruction words from individual storage units 116A, 116B, . . . 116N to individual execution units 118A, 118B, . . . 118N on each clock cycle. The example interconnect device 114 is an N-to-N interconnect, which means that it can make a communication link between any one of the N storage units and any one of the N execution units. For instance, the interconnect device 114 can provide a connection from the first storage unit 116A to the first execution unit 118A, to the second execution unit 11B or any other execution unit in the VLIW processor device 117.

The example interconnect device 114 is adapted to access routing indices for each clock cycle of the VLIW processor device 117. In some cases, the interconnect device 114 can access the routing indices from the pre-fetch queue 120. The routing indices can be formatted, for example, as a binary vector, a binary string, or another format. The routing indices for a clock cycle indicate which execution unit should receive non-NOP instruction words for execution during the clock cycle. In this manner, the routing indices provide instructions for the routing logic of the interconnect device 114.

In some instances, the interconnect device 114 provides direct connections from individual storage units to the respective, individual execution units for each clock cycle. The connections for each clock cycle can be configured according to the routing indices for the clock cycle. The routing indices for a clock cycle can be a set of N binary values, with one binary routing index for each of the execution units 118A, 118B, . . . 118N. For example, the routing indices for a clock cycle of the VLIW processor device 117 can be the N binary values in any individual row of the example routing matrix 208 shown in FIG. 2. In some cases, other types of routing indices can be used.

The interconnect device 114 can include digital or analog circuitry that can be controlled according to routing indices or other instructions. In the example shown in FIG. 1B, the routing logic of the example interconnect device 114 is adapted to route instruction words for each clock cycle of the VLIW processor device 117 from one or more of the storage units 116A, 116B, . . . 116N to one or more of the execution units 118A, 118B, . . . 118N. For each clock cycle, the connections between storage units and execution units is configured according to the routing indices for the clock cycle. For instance, the routing indices for a clock cycle may indicate a subset (one or more) of the execution units that are to receive an instruction word for the clock cycle. As a result of processing the routing indices, the interconnect device 114 can provide connections between the subset of execution units and the storage units where the instruction words are stored.

In some cases, the interconnect device 114 can be implemented as an N:N cross-switch that is controlled by the routing information stored in the index store 119. By controlling the connections and allowing them to be reconfigured according to routing indices upon each clock cycle, memory allocation assumptions can be eliminated or reduced, and the memory devices can be filled generally and compactly, which may enable improved compression and utility in some instances. For instance, operating the interconnect device 114 in this manner can avoid certain scenarios where pre-allocation would otherwise restrict program size, for instance, due to a program that makes higher use of a particular execution unit.

In some examples, the routing indices for each clock cycle specify which execution units of the VLIW processor device need to be fed an instruction word for that clock cycle. In this manner, the instructions words can be routed from individual storage units directly to the proper respective execution units. And the routing between storage units and execution units can change upon each clock cycle. For example, the communication paths between storage units and execution units can be reconfigured upon each clock cycle, and the reconfigured communication paths can be used to transfer instruction words from storage units to respective execution units.

As an example of how the connections can be changed for each clock cycle, the interconnect device 114 can provide a first connection between the first storage unit 116A and the first execution unit 118A according to the routing indices for a first clock cycle; and the interconnect device 114 can then change the connections to provide a second, different connection between the first storage unit 116A and the second execution unit 118B according to the routing indices for a second clock cycle. In this example, the interconnect device 114 can use the first connection to route a first instruction word from the first storage unit 116A to the first execution unit 118A, and the interconnect device 114 can then use the second connection to route a second instruction word from the first storage unit 116A to the second execution unit 118B. The first instruction word can be executed by the first execution unit 118A during the first clock cycle, and the second instruction word can then be executed by the second execution unit 118B during the second clock cycle.

The example index store 119 stores the routing indices that are accessed by the interconnect device 114. For instance, the index store can store a routing matrix, such as, for example, all or part of the example routing matrix 208 shown in FIG. 2. The index store 119 may store routing indices of another type or format.

The example pre-fetch queue 120 can serve as a pipelined buffer between the index store 119 and the interconnect device 114. The pre-fetch queue 120 can be sized, e.g., to the number of delay slots of the VLIW processor device 117 and can contain routing codes that are requested well in advance of instruction execution. In some instances, during a change of control flow (e.g., a program jump), the routing codes already queued can continue to control the routing logic until all delay slots have been executed.

The example VLIW processor device 117 is a processor device that performs logical operations by executing instructions. The N execution units 118A, 118B, . . . 118N of the VLIW processor device 117 can operate in parallel and execute instructions concurrently on each clock cycle of the VLIW processor device 117. Generally, each execution unit operates by executing an instruction word received from one of the storage units. The routing indices for each clock cycle indicate, for each execution unit, whether the execution unit receives an instruction word to be executed on the clock cycle. In some instances, one or more execution units 118A, 118B, . . . 118N does not operate during one or more clock cycles, for instance, during a clock cycle for which the execution unit receives an NOP instruction word. The execution units 118A, 118B, . . . 118N of the VLIW processor device 117 can include logic circuitry or other data processing hardware configured to process instruction words. In operation, the execution units perform the arithmetic and logic workload of the VLIW processor device 117, as well as load and store operations, etc.

The example processor system 110 can store and process instructions according to a general compression scheme (e.g., the scheme represented by the example shown in FIG. 2). For instance, in some implementations, any of the N storage units 116A, 116B, . . . 116N can store any instruction word, for any clock cycle, for any of the execution units 118A, 118B, . . . 118N. As the program execution proceeds, a control unit of the VLIW processor unit 117 can determine how many instruction words to fetch and from which of the N storage units 116A, 116B, . . . 116N to fetch them. The control unit can make this determination, for example, by using a register to point to the current “head” storage unit, and then performing a reduction add on the routing indices from the instruction memory. The head pointer can then be updated accordingly to point to the start of the next instruction. Once the head pointer increments past the number of storage units, it can wrap around in cyclical fashion. Similarly, fetches of instructions can wrap around as well. In some cases, the instruction words can be re-ordered during an operation that expands the fetched instruction words into a VLIW issue using the routing indices.

FIG. 2 is a schematic diagram showing certain aspects an example instruction set 200 that can be processed by the processor system 110. The example instruction set 200 shown in FIG. 2 includes a routing matrix 208 and a set of instruction words 210. The example routing matrix 208 is an M×N matrix, having M rows and N columns (where M and N are both integers). Each row of the routing matrix 208 includes routing indices for a single clock cycle of a VLIW processor device. For instance, the routing indices in the first row are for a first clock cycle, the routing indices in the second row are for a second clock cycle, and the routing indices in the M^{th} row are for an M^{th} clock cycle. Each column in the routing matrix 208 corresponds to an execution unit in the VLIW processor device. For instance, the routing indices in the first column are for execution by a first execution unit, the routing indices in the second column are for execution by a second execution unit and the routing indices in the N^{th} row are for execution by the N^{th} execution unit. For the first clock cycle in the example shown in FIG. 2, “1” is the routing index for the first, third and N^{th} execution units, and “0” is the routing index for the second execution unit; for the second clock cycle in the example shown in FIG. 2, “1” is the routing index for the first and second execution units, and “0” is the routing index for the third and N^{th} execution units; etc.

In the example shown in FIG. 2, each binary index in the routing matrix 208 indicates whether a non-NOP instruction is routed to an execution unit. In particular, each “0” index indicates an NOP instruction, and each “1” index indicates a non-NOP instruction. The non-NOP instructions are explicitly provided in the set of instruction words 210, and the NOP instructions are not explicitly stored. For instance, each non-NOP instruction in the instruction set 200 can be an n-bit value in the set of instruction words 210.

In the example shown in FIG. 2, the set of instruction words 210 is stored as an array of n-bit values. The instruction words for the first clock cycle are shown in FIG. 2 as {a₁₁, a₁₃, and a_{1N}}, and the instruction words for the second clock cycle are shown in FIG. 2 as {a₂₁ and a₂₂}, etc. In this example, a₁₁ represents the instruction word for the first execution unit on the first clock cycle, a₁₃ represents the instruction word for the third execution unit on the first clock cycle, a₂₁ represents the instruction word for the first execution unit on the second clock cycle, etc.

The example set of instruction words 210 shown in FIG. 2 does not include any NOP instruction words. Instead, the NOP instruction words are represented as “0” indices in the routing matrix 208. Therefore, for example, the set of instruction words 210 does not include an instruction word for the second execution unit on the first clock cycle, for the third execution unit on the second clock cycle, or other slots that correspond to a “0” index in the routing matrix.

The example instruction set 200 shown in FIG. 2 represents M×N instruction words, and there are M×N binary indices in the routing matrix 208. In this example, the number of NOP instructions can be represented as the integer α, which means there are α “0” indices and (M×N−α) “1” indices in the routing matrix 208. In this example, each of the individual non-NOP instruction words is as an n-bit value, which means that (M×N−α)×n bits are used to store the set of instruction words 210. Therefore, the total number of bits used to store the example instruction set 200 is (M×N−α)×n+(M×N). In many cases, the instruction set 200 requires less total memory than another format. For instance, in an alternative format where all NOP and non-NOP instructions are explicitly stored, (M×N×n) bits of memory are used to store the instruction set. Comparing to this alternative, the format shown in FIG. 2 consumes less memory when the number of NOP instructions is greater than the total number of operations (NOP and non-NOP) divided by the bit size of each operation (i.e., when ≧(M×N)/n)).

In some example implementations, the instruction set 200 shown in FIG. 2 can be stored and processed in the processor system 110 shown in FIG. 1B. In such an examples, x instruction words a₁₁, a₁₃, . . . a_{1N} for the first clock cycle can be stored on the first x storage units (e.g., storage unit 116A, storage unit 116B, etc.) in the cache 115, and N−x of the instruction words for the second clock cycle can be stored on the remaining N−x storage units. For instance, the first N of the instruction words 210 can be communicated from the main store 111 over the bus 113 to the cache 115 by operation of the DMA unit 112. The interconnect device 114 can receive the routing indices for the first clock cycle from the pre-fetch queue 120. The routing logic of the interconnect device 114 can route the instruction words from the first x storage units to the appropriate x execution units in the VLIW processor device 117 to be executed during the first clock cycle. For instance, the instruction word a₁₁ can be routed from the first storage unit 116A to the first execution unit 118A, the instruction word a₁₃ can be routed from the second storage unit 116B to the third execution unit 118C, the instruction word a_{1N} can be routed from the x^{th} storage unit to the N^{th} execution unit 118N, etc. In some cases, the interconnect device 114 can then receive the routing indices for the second clock cycle from the pre-fetch queue 120, and the routing logic can route the instruction words from the remaining N−x storage units to the appropriate execution units in the VLIW processor device 117 to be executed during the second clock cycle.

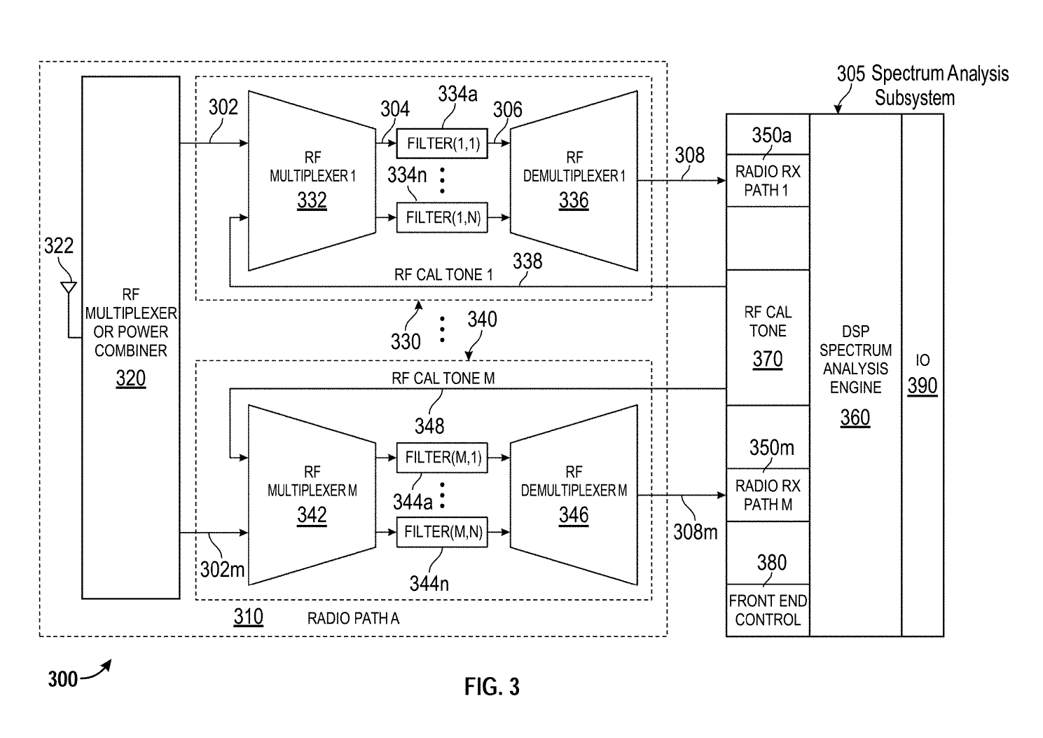

FIG. 3 is a schematic diagram showing an example signal path 300 that can be implemented in a wireless sensor device. Other types of signal paths may be used for processing signals in a wireless sensor device. The example signal path 300 shown in FIG. 3 includes an RF interface 310 (denoted as “Radio Path A” in FIG. 3) and a spectrum analysis subsystem 305. A signal path can include additional or different features, which may be configured as shown or in another manner. In some cases, the system shown in FIG. 3 can perform all operations for monitoring and analyzing wireless signals in a wireless sensor device. For example, the signal path 300 can perform functions of a wireless receiver such as demodulation, equalization, channel decoding, etc. The signal path 300 can support signal reception of various wireless communication standards and access the spectrum analysis subsystem 305 for analyzing the wireless signals.

In the example shown, the RF interface 310 can include a wideband or narrowband front-end chipset for detecting and processing RF signals. For example, the RF interface 310 can be configured to detect RF signals in a wide spectrum of one or more frequency bands, or a narrow spectrum within a specific frequency band of a wireless communication standard. In some implementations, the signal path 300 can include one or more RF interfaces 310 to cover the spectrum of interest.

In the example shown in FIG. 3, the RF interface 310 includes an antenna system 322, an RF multiplexer 320 or power combiner (e.g., an RF switch), and one or more signal processing paths (e.g., “path 1” 330, . . . , “path M” 340). The example antenna system 322 in FIG. 3 is connected to the RF multiplexer 320. In some implementations, the RF interface 310 can be configured to use the antenna system 322 for detecting the RF signals based on single-input single-output (SISO), single-input and multiple-output (SIMO), multiple-input and single-output (MISO), or multiple-input and multiple-output (MIMO) technologies.

In some implementations, an RF signal in the local environment of a wireless sensor device can be picked up by the antenna system 322 and input into the RF multiplexer 320. Depending on the frequency of the RF signal, the signal 302 output from the RF multiplexer 320 can be routed to one of the processing paths (i.e., “path 1” 330, . . . , “path M” 340, where M is an integer). Each path can include a distinct frequency band. For example, “path 1” 330 may be used for RF signals between 1 GHz and 1.5 GHz, while “path M” may be used for RF signals between 5 GHz and 6 GHz. The multiple processing paths may have a respective central frequency and bandwidth. The bandwidths of the multiple processing paths can be the same or different. The frequency bands of two adjacent processing paths can be overlapping or disjointed. In some implementations, the frequency bands of the processing paths can be allocated or otherwise configured based on the assigned frequency bands of different wireless communication standards (e.g., GSM, LTE, WiFi, etc.). For example, it can be configured such that each processing path is responsible for detecting RF signals of a particular wireless communication standard. As an example, “path 1” 330 may be used for detecting LTE signals, while the “path M” 340 may be used for detecting WiFi signals.

Each processing path (e.g., “processing path 1” 330, “processing path M” 340) can include one or more RF passive and RF active elements. For example, the processing path can include an RF multiplexer, one or more filters, an RF de-multiplexer, an RF amplifier, and other components. In some implementations, the signals 302, 302m output from the RF multiplexer 320 can be applied to a multiplexer in a processing path (e.g., “RF multiplexer 1” 332, . . . , “RF multiplexer M” 342). For example, if “processing path 1” 330 is selected as the processing path for the signal 302, the signal 302 can be fed into “RF multiplexer 1” 332. The RF multiplexer can choose between the signal 302 coming from the first RF multiplexer 320 or the RF calibration (cal) tone 338 provided by the spectrum analysis subsystem 305. The output signal 304 of “RF multiplexer 1” 332 can go to one of the filters, Filter(1,1) 334a, . . . , Filter (1,N) 334n, where N is an integer. The filters further divide the frequency band of the processing path into a narrower band of interest. For example, “Filter(1,1)” 334a can be applied to the signal 304 to produce a filtered signal 306, and the filtered signal 306 can be applied to “RF de-multiplexer 1” 336. In some instances, the signal 306 can be amplified in the RF de-multiplexer. The amplified signal 308 can then be input into the spectrum analysis subsystem 305.

Similarly, if “processing path M” 340 is selected as the processing path for the signal 302m, the signal 302m can be fed into “RF multiplexer M” 342. The RF multiplexer can choose between the signal 302m coming from the first RF multiplexer 320 or the RF calibration (cal) tone 348 provided by the spectrum analysis subsystem 305. The output signal of “RF multiplexer M” 342 can go to one of the filters, Filter(M,1) 344a, . . . , Filter (M,N) 344n, where N is an integer. In some instances, the output signal of the filters can be amplified in the RF de-multiplexer M 346. The amplified signal 308m can then be input into the spectrum analysis subsystem 305.

The spectrum analysis subsystem 305 can be configured to convert the detected RF signals into digital signals and perform digital signal processing to identify information based on the detected RF signals. The spectrum analysis subsystem 305 can include one or more SI radio receive (RX) paths (e.g., “Radio RX path 1” 350a, “Radio RX path M” 350m), a DSP spectrum analysis engine 360, an RF calibration (cal) tone generator 370, a front-end control module 380, and an I/O 390. The spectrum analysis subsystem 305 may include additional or different components and features.

In the example shown, the amplified signal 308 is input into “Radio RX path 1” 350a, which down-converts the signal 308 into a baseband signal and applies gain. The down-converted signal can then be digitalized via an analog-to-digital converter. The digitized signal can be input into the DSP spectrum analysis engine 360. In some cases, the spectrum analysis subsystem 305 includes one or more processor devices, such as, for example, a very long instruction word (VLIW) processor device, a Digital Signal Processor (DSP) device, or a combination of these and other types of processor devices. In some cases, the VLIW processor device receives instructions through an interconnect that routes the instructions according to routing indices. For example, the spectrum analysis subsystem 305 can include the processor system 110 shown in FIG. 1B or another type of processor system.

The DSP spectrum analysis engine 360 can, for example, identify packets and frames included in the digital signal, read preambles, headers, or other control information embedded in the digital signal (e.g., based on specifications of a wireless communication standard), determine the signal power and SNR of the signal at one or more frequencies or over a bandwidth, channel quality and capacity, traffic levels (e.g., data rate, retransmission rate, latency, packet drop rate, etc.), or other parameters. The output (e.g., the parameters) of the DSP spectrum analysis engine 360 can be applied and formatted to the I/O 390, for example, for transmission to an external system.

The RF calibration (cal) tone generator 370 can generate RF calibration (cal) tones for diagnosing and calibration of the radio RX paths (e.g., “Radio RX path 1” 350a, . . . “Radio RX path M” 350m). The radio RX paths can be calibrated, for example, for linearity and bandwidth.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

A number of embodiments have been described. Nevertheless, it will be understood that various modifications can be made. Accordingly, other embodiments are within the scope of the following claims.

What is claimed is:

1. A wireless sensor device comprising a radio frequency (RF) processor system, the RF processor system comprising:
a very large instruction word (VLIW) processor device comprising execution units;
storage units that store instruction words to be routed to the execution units; and
an interconnect device providing connectivity between the storage units and the execution units, the interconnect device adapted to:
access routing indices for a clock cycle of the VLIW processor device; and
route the instruction words from one or more of the storage units to one or more of the execution units according to the routing indices for the clock cycle.

2. The wireless sensor device of claim 1, wherein the routing indices for the clock cycle indicate, for each execution unit, whether the execution unit receives an instruction word to be executed on the clock cycle.

3. The wireless sensor device of claim 1, wherein the routing indices include a binary value representing an NOP instruction for one of the execution units.

4. The wireless sensor device of claim 1, wherein the VLIW processor device comprises N execution units, and the RF processor system comprises:
N storage units; and
an N-to-N interconnect device that provides N-to-N connectivity between the N storage units and the N execution units.

5. The wireless sensor device of claim 1, further comprising an index store that stores routing indices for multiple clock cycles, wherein the interconnect devices is adapted to access the routing indices for each clock cycle.

6. The wireless sensor device of claim 5, wherein the index store stores a binary routing matrix that includes the routing indices for the multiple clock cycles.

7. The wireless sensor device of claim 1, further comprising a main storage device that stores instruction words to be communicated to the storage units.

8. A method of handling instruction words in a processor system, the method comprising:
storing, at respective storage units in a processor system, instruction words to be routed to execution units of a very large instruction word (VLIW) processor device in the processor system; and
by operation of an interconnect device that provides connectivity between the storage units and the execution units:
accessing routing indices for a clock cycle of the VLIW processor device; and
routing the instruction words from one or more of the storage units to one or more of the execution units according to the routing indices for the clock cycle.

9. The method of claim 8, comprising, by operation of the interconnect device:
providing a first connection between a first one of the storage units and a first one of the execution units according to the routing indices for the clock cycle; and
routing a first one of the instruction words from the first storage unit to the first execution unit through the first connection.

10. The method of claim 9, wherein the clock cycle comprises a first clock cycle, and the method comprises, by operation of the interconnect device:
providing a second, different connection between the first storage unit and a second, different one of the execution units according to routing indices for a second, subsequent clock cycle; and
routing a second instruction word from the first storage unit to the second execution unit through the second connection.

11. The method of claim 8, comprising, by operation of the interconnect device, changing connections between the storage units and execution units according to routing indices for sequential clock cycles of the VLIW processor device.

12. The method of claim 8, comprising storing a binary routing matrix at an index store in the processor system, the binary routing matrix comprising routing indices for multiple clock cycles of the VLIW processor device.

13. The method of claim 8, further comprising communicating the instruction words from a main storage device to the storage units.

14. A processor system comprising:
a very large instruction word (VLIW) processor device comprising execution units;
storage units that store instruction words to be routed to the execution units; and
an interconnect device providing connectivity between the storage units and the execution units, the interconnect device adapted to:
access routing indices for a clock cycle of the VLIW processor device; and
route the instruction words from one or more of the storage units to one or more of the execution units according to the routing indices for the clock cycle.

15. The processor system of claim 14, wherein the interconnect device comprises routing logic that is operable to change connections between the storage units and the respective execution units according to the routing indices for sequential clock cycles of the VLIW processor device.

16. The processor system of claim 14, wherein the routing indices for the clock cycle indicate, for each execution unit, whether the execution unit receives an instruction word to be executed on the clock cycle.

17. The processor system of claim 14, wherein the routing indices include a binary value representing an NOP instruction for one of the execution units.

18. The processor system of claim 14, wherein the VLIW processor device comprises N execution units, and the RF processor system comprises:
N storage units; and
an N-to-N interconnect device that provides N-to-N connectivity between the N storage units and the N execution units.

19. The processor system of claim 14, further comprising an index store that stores routing indices for multiple clock cycles.

20. The processor system of claim 14, further comprising a main storage device that stores instruction words to be communicated to the storage units.
